(19) United States
(12) Patent Application Publication
(10) Pub. No.: US 2004/0052270 A1
(43) Pub. Date: Mar. 18, 2004

(54) Rolling history display of multi-slot channel contents

(76) Inventor: Kathryn A. Engholm, Beaverton, OR (US)

Correspondence Address: Francis I. Gray, TEKTRONIX, INC., MS 50-LAW, P.O. BOX 500, Beaverton, OR, 97077, US

(21) Appl. No.: 10/246,924

(22) Filed: Sep. 18, 2002

(51) Int. Cl. H04B 7/212

(52) U.S. Cl. 370/442

(57) ABSTRACT

A rolling history display of multi-slot channel contents displays the contents for all channels from an acquisition record at a single point in time as a line of icons. Each new acquisition record is added as another line of icons to the display, with the initial line of icons shifted to make room for the new line. This repeats for a period of time specified by an operator, showing the operator a continuous stream of graphical information for each channel across the period of time.

### BACKGROUND OF THE INVENTION

The present invention relates to the display of time-division multiplexed communications signals, and more particularly to a rolling history display of multi-slot channel contents for viewing channel contents over a period of time.

In a time-division multiplexed communications signal, such as T1 or E1 telephony, there are multiple data streams packaged into a single physical channel. For example a single T1 carrier in a residential neighborhood may be carrying a control channel, many voice communications, a few modem sessions and some idle channels on its twenty-four (24) time slots or channels at a given instant in time. Many other content types and combinations are also possible and may exist on the same T1 carrier at some other given instant in time. An operator, simply looking at the electrical signal on the T1 line, cannot interpret what content types are present in the various channels or even whether any or all of the channels are working correctly.

Current methods for examining the channels—time slots in the case of T1 and E1 telephony carriers—allow the operator to examine any or all of the channels at a single point in time to determine whether it contains the correct content type and is operating properly. Protocol analyzers are a typical instrument for this purpose. The common method for displaying the information to the operator is to write the channel data as text on a screen or in a file. More recently, as exemplified by the Tektronix K1205 Protocol Testers' graphical display called “PCMCheck”, small graphic icons may be used instead of text to indicate what content type is found in each channel of a T1 or E1 carrier. This is an improvement in usability, but doesn't address the problem that only the information from a single point in time is viewed.

As users frequently need to know what happened in the past or over some period of time in order to understand why some later event occurred, what is desired is a way to compress the information from series of time points into a single, useful view for display.

### BRIEF SUMMARY OF THE INVENTION

Accordingly the present invention provides a rolling history display of multi-slot channel contents that displays the contents for all channels from an acquisition record at a single point in time as a line of icons. Each new acquisition record is added as another line of icons to the display, with the initial line of icons shifted to make room for the new line. This repeats for a period of time specified by an operator, showing the operator a continuous stream of graphical information for each channel across the period of time.

The objects, advantages and other novel features of the present invention are apparent from the following detailed description when read in conjunction with the appended claims and attached drawing.

### BRIEF DESCRIPTION OF THE SEVERAL VIEWS OF THE DRAWING

FIG. 1 is a block diagram view of a typical instrument that provides a rolling history display according to the present invention.

FIG. 2 is a flow diagram view for the instrument of FIG. 1 that generates the rolling history display according to the present invention.

FIG. 3 is a plan view of a screen for the instrument of FIG. 1 illustrating the rolling history display according to the present invention.

### DETAILED DESCRIPTION OF THE INVENTION

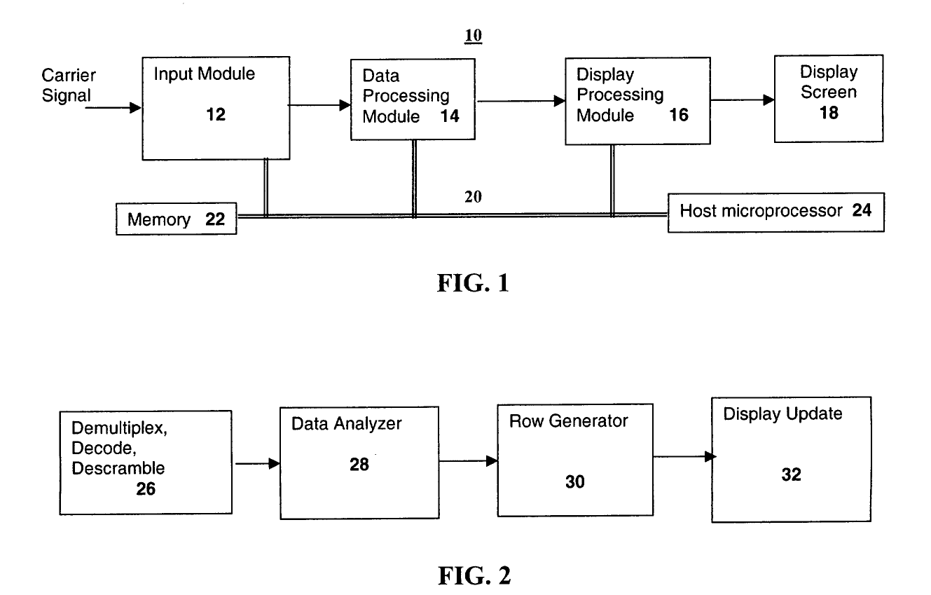

Referring now to FIG. 1 an instrument 10 has as an input a communications or carrier signal having multiple channels of information. Such an input stream may include T1 or E1 telephony having multiple channels or a Motion Picture Experts Group (MPEG) Transport Stream which has multiple programs containing elementary streams. The input signal is demultiplexed, decoded and descrambled, as necessary according to the communication protocol being used, in an input module 12 to produce individual channels or streams. The individual channels or streams are input to a data processing module 14 where information about each channel or stream is extracted, such as channel or program identification, type of information or other data. The extracted data for each channel is then input to a display processing module 16 for appropriate display formatting. The formatted data is then provided on a display screen 18 for viewing by an operator. The input module 12, data processing module 14 and display processing module 16 may be coupled via a conventional computer bus 20 to appropriate memory devices 22 and a host control processor 24.

As shown in FIG. 2 the input signal is broken down into its individual channels or programs (step 26), and then each channel or program is analyzed (step 28) to extract the desired data, such as type of information in the channel or stream. These first two steps are implicit in any communications signal analyzer. Next a display line is created (step 30) for the input signal with an icon in each channel slot, the icon based upon the type of information in the channel. Then (step 32) the current display is updated by adding the new line to the display, moving the already existing lines, if any, to make room for the new line, and removing the oldest line from the display when the display is full.

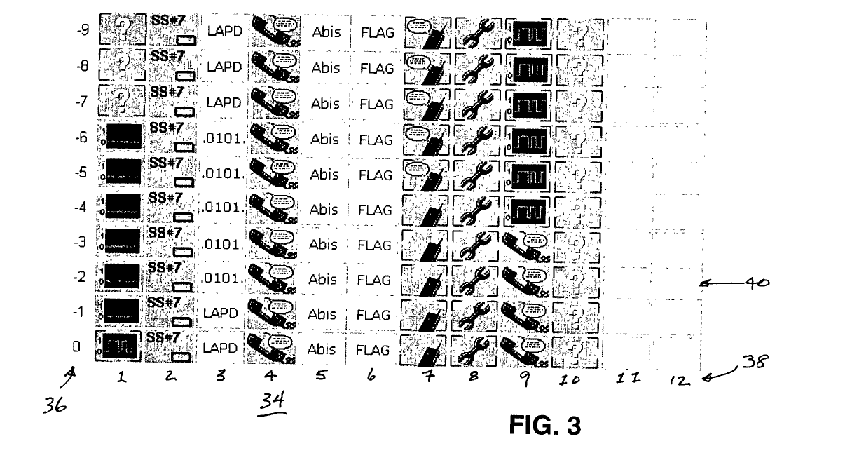

The resulting display 34 is shown in FIG. 3 where acquisition records are indicated along the left-hand, vertical axis 36 and channel or program numbers 38 are indicated or inferred along the bottom, horizontal axis. Only 10 records of data are shown for this illustration, each represented by a row of icons. For a T1 or E1 carrier each row would contain 24 or 32 icons, respectively. For an MPEG Transport Stream the number of icons per row depends upon the number of programs found or specified manually by the operator. Each line 40 has the appropriate icon in each channel indicative of the content or data for that channel. As shown the bottom row represents the most current data and the top row shows the oldest data. In the earliest measurements for channel 1 the protocol analysis software of the data processing module 14 determined that the content was some unknown type of TRAU (Transcoding Rate Adaption Unit) frame. Later at time −6 the content is determined to be an idle pattern and is represented by an idle icon. Finally at the current measurement the content is detected as TRAU User Data, represented by a data icon. Seeing this the operator may be able to correlate the change from UNKNOWN to IDLE to some external event, helping an understanding of the system response. This display may be used to watch for correlation between channels in the same carrier, or to roughly measure the duration of some condition within one or more channels.

The icons shown in this representation may be related to telephony protocols, but there are an infinite number of icons that could be designed to represent various properties of the channel contents and/or format. This display pertains to other types of encoded, multi-channel carriers outside of the telephony domain, such as program information about elementary streams within an MPEG Transport Stream over time, as indicated above. The display presents a time history of the input signal for each channel of the input carrier using appropriate icons to indicate channel content, the information being updated with each new acquisition.

Although illustrated in FIG. 3 as being displayed as horizontal rows with the records moving vertically as new records are added, the records may be displayed as vertical columns with the records moving horizontally as new records are added.

Thus the present invention provides a rolling history display of multi-channel contents for an input carrier or signal by extracting content information for each channel of a multi-channel carrier signal at a point in time, generating from the content information a line of icons, one icon for each channel that is representative of the content information for that channel, displaying the line of icons together with prior lines of icons representing prior points in time, and repeating the steps for each subsequent point in time.

What is claimed is:

1. An apparatus for providing a rolling history display of the contents of each channel in a multi-channel carrier signal comprising:
means for extracting content information for each channel at a point in time;
means for generating a line of icons for the content information, each icon in the line corresponding to one of the channels of the multi-channel carrier signal and uniquely representing the corresponding content information; and
means for updating the rolling history display by adding the line to prior lines representing prior points in time for the multi-channel carrier signal.

2. A method of providing a rolling history display of the contents of each channel in a multi-channel carrier signal comprising:
extracting content information for each channel at a point in time;
generating a line of icons for the content information, each icon in the line corresponding to one of the channels of the multi-channel carrier signal and uniquely representing the corresponding content information; and
updating the rolling history display by adding the line to prior lines representing prior points in time for the multi-channel carrier signal.
